(19) United States
(12) Patent Application Publication
(10) Pub. No.: US 2002/0090122 A1
(43) Pub. Date: Jul. 11, 2002

(54) Road map image guide for automated microdissection

(76) Inventors: Thomas M. Baer, Mountain View, CA (US); Norbert Hagen, Livermore, CA (US); Bruce J. Richardson, Los Gatos, CA (US); David R. Brewer III, Aptos, CA (US); Lisa Reese, Felton, CA (US)

Correspondence Address: Shantanu Basu, Morrison & Foerster LLP, 755 Page Mill Road, Palo Alto, CA, 94304-1018, US

(21) Appl. No.: 10/011,515

(22) Filed: Nov. 5, 2001

Related U.S. Application Data
(60) Provisional application No. 60/245,884, filed on Nov. 3, 2000.

(51) Int. Cl. G02B 21/36

(52) U.S. Cl. 382/128; 396/432

(57) ABSTRACT

Systems and methods for capturing and using a road map image for guiding microscopy and microdissection are disclosed. Systems for using a static reference road map image for navigation and analysis of a live image of a sample are provided. A road map camera for capturing a low resolution reference image of the sample is disclosed. Novel methods for computer-controlled navigation of the road map image are provided.

### CROSS-REFERENCE TO RELATED APPLICATION

This application claims priority of U.S. Provisional Application No. 60/245,884, filed Nov. 3, 2000 entitled “Automated Laser Capture Microdissection” by the same inventors, the entire contents of which are hereby incorporated herein by reference as if fully set forth herein.

### TECHNICAL FIELD OF THE INVENTION

The invention relates generally to the field of microscopy. In particular, the invention relates to the field of microdissection and more particularly, to the field of laser capture microdissection (LCM). Specifically, preferred embodiments of the invention relate to a road map image guide which provides a reference image of the whole sample used to orient the user to specific locations on the sample under view through the microscope.

### BACKGROUND OF THE INVENTION

When performing microscopy, it is desirable to have a readily available image of the entire sample in order to orient the user as to the specific location on the sample they are looking at, and in order to know where the image they are looking at resides with respect to other features on the specimen.

Microdissection is used to procure specific regions or specific cells from tissue sections or cell smears. In order to enhance the ability to visualize and procure the small sections desired for microdissection, it is desirable to provide a magnified image of the sample. Laser capture microdissection (LCM) is a rapid, reliable method for procuring pure populations of targeted cells from specific microscopic regions of tissue sections for subsequent analysis. LCM-based molecular analysis of histopathological lesions can be applied to any disease process that is accessible through tissue sampling. Examples include mapping the field of genetic changes associated with the progression of microscopic premalignant cancer lesions; analysis of gene expression patterns in multiple sclerosis, atherosclerosis and Alzheimer's disease plaques; infectious microorganism diagnosis; typing of cells within disease foci; and analysis of genetic abnormalities in utero from selected rare fetal cells in maternal fluids.

The LCM technique is generally described by Emmert-Buck et al., Science 274, 998 (1996), the entire contents of which are incorporated herein by reference. The purpose of the LCM technique is to provide a simple method for the procurement of selected human cells from a heterogeneous population contained on a typical histopathology biopsy slide. In an LCM method, a transfer surface is placed onto the tissue section and then focally bonded to the targeted tissue, allowing it to be selectively removed for molecular analysis. In the microscope, the operator views the tissue and selects microscopic clusters of cells for analysis, then activates a laser within the microscope optics. The pulsed laser beam is absorbed within a precise spot on the transfer film immediately above the targeted cells. At this precise location, the film melts and fuses with the underlying cells of choice. When the film is removed, the chosen cells remain bound to the film, while the rest of the tissue is left behind. The exact morphology of the procured cells is retained and held on the transfer film. While LCM is a preferred method of microdissection, other microdissection methods, such as those utilizing cutting lasers, can benefit from the use of the instant invention.

In a manually operated microdissection system, the operator looks through a microscope at a tissue biopsy section mounted on a standard glass histopathology slide, which typically contains groups of cells. A thermoplastic film is placed over and in contact with the tissue biopsy section. Upon identifying a cell, or group of cells, of interest within the tissue section, the operator centers them in a target area of the microscope field and then generates a pulse from a laser such as a carbon dioxide laser having an intensity of about 50 milliwatts (mW) and a pulse duration of between about 50 to about 500 milliseconds (mS). The laser pulse causes localized heating of the plastic film as it passes through it, imparting to it an adhesive property. The cells then stick to the localized adhesive area of the plastic tape directly above them, whereupon the cells are extracted and readied for analysis. Because of the small diameter of the laser beam, extremely small clusters of cells may be microdissected from a tissue section.

By taking only these target cells directly from the tissue sample, researchers can immediately analyze the gene and enzyme activity of the target cells using other research tools. Such procedures as polymerase chain reaction amplification of DNA and RNA, and enzyme recovery from the tissue sample have been demonstrated. No limitations have been reported in the ability to amplify DNA or RNA from tumor cells extracted by microdissection.

A typical tissue biopsy sample consists of a 5 to 10 micron slice of tissue that is placed on a glass microscope slide using techniques well known in the field of pathology. This tissue slice is a cross section of the body organ that is being studied. The tissue consists of different types of cells. Often a pathologist desires to remove only a small portion of the tissue for further analysis.

### SUMMARY OF THE INVENTION

A method for automating a microdissection is provided comprising providing a fluorescently-labeled tissue sample on a microscope slide, wherein the fluorescent label on the tissue corresponds to a biological property of interest; providing a source of fluorescent excitation, wherein an excitation beam emitted by the source is of an intensity and wavelength to excite a fluorescent label associated with the labeled tissue sample; exciting the tissue sample with the excitation beam and recording at least one information corresponding to an excitation pattern of the tissue sample; selecting from the recorded information, at least one section of the tissue sample for capture by microdissection; and targeting a laser for selectively capturing the at least one section of the tissue sample by microdissection.

In the method the at least one information corresponding to an excitation pattern of the tissue sample is a set of positional coordinates of sections of the tissue sample with increased fluorescence. The source of fluorescent excitation can be an EPI laser lamp. The method may further comprise: analyzing the captured image of the fluorescent tissue sample by scanning the image for locations of enhanced fluorescence; and responsive to the scanned information, selecting one or more sections of the tissue sample for microdissection.

In another aspect the method comprises analyzing the captured image of the fluorescent tissue sample by displaying the image in a video monitor; and selecting locations of enhanced fluorescence on the tissue sample by inputting a selection into an I/O device.

A road map camera system is provided for capturing an image of a sample in a microscopy apparatus, wherein the microscopy apparatus comprises a work surface comprising at least one sample, the system comprising: a road map camera comprising an objective lens, coupled to the work surface such that the road map camera and the work surface are able to translate in two dimensions relative to each other; at least one light source to illuminate the sample; and a system to display an image captured by the camera. In one embodiment the sample is a tissue sample provided on a microscopy slide. In one aspect, the microscopy apparatus further comprises a cap transfer mechanism subassembly and the road map camera is coupled to the cap transfer mechanism subassembly. In one embodiment, the road map camera is stationary and the work surface is translatable. In another embodiment, the road map camera is translatable and the work surface is stationary. The microscopy apparatus of the instant invention may be a microdissection apparatus or a laser capture microdissection (LCM) apparatus.

A road map imaging system for a microscopy apparatus is also provided, the system comprising: a sample; an image capture mechanism for capturing an image of the sample; a video display for displaying the captured image; means for storing and displaying on the video display a static first captured reference image within a first display window; means for selecting a section of the first captured reference image; and means for displaying a second live captured image within a second display window wherein the second live captured image corresponds to the selected section of the first captured reference image. The first captured reference image is used as a reference for navigating the image and selecting sections of the image for magnification and inspection. In one aspect of the system, selecting a section of the first captured reference image is coupled to the an image capture mechanism for capturing an image of the sample.

In one embodiment the sample is a tissue sample provided on a microscopy slide. In one aspect, the image capture mechanism is a camera. In one aspect, the label on the tissue corresponds to a biological property of the tissue sample. In one aspect, the label on the tissue is a fluorescent label. Another aspect of the system comprises means for selecting the section of the slide corresponding to an increased or decreased presence of label in the selected section. The video display is preferably a high resolution video display. The means for selecting and displaying the images on the video display are controlled by at least one microprocessor.

In one embodiment, the first captured reference image within the first display window comprises an image of the entire sample. The image of the entire sample is composed by stitching together at least two captured images comprising portions of the sample. The selected section of the first captured reference image can be moved dynamically and is coupled to the second live image. In another embodiment, the first captured reference image is captured using a low resolution image capture mechanism and the second live captured image is captured using a high resolution image capture mechanism.

In one embodiment, the imaging system of further comprises: means for displaying a navigational toolbar on a video display; and means for navigating the static image by translating the slide relative to the image capture mechanism. The toolbar may be controlled by a microprocessor. A virtual joystick may be used as the navigational toolbar.

The system further comprises means for predefined precision movements of the navigational toolbar. The precision movement of the navigational toolbar is defined by a specified distance translated in a specified direction caused by a single instruction to the navigational toolbar.

In another aspect of the invention, a method of selecting a sample for microscopy by using a road map image is provided, the method comprising: providing a sample; capturing an image of at least a portion of the sample; displaying a first captured reference image within a first display window; selecting a section of the first captured reference image; and displaying a second live captured image within a second display window wherein the second live captured image corresponds to the selected section of the first captured reference image. Selecting a section of the first captured reference image is coupled to capturing an image of at least a portion of the sample.

In one embodiment, composing the first captured reference image of the entire sample comprises stitching together at least two captured images comprising portions of the sample. In another embodiment, the method further comprises capturing the first captured reference image using a low resolution image capture mechanism; and capturing the second live captured image using a high resolution image capture mechanism.

The method further comprises displaying a magnified image of the selected section of the sample, wherein the magnified image of the selected section of the sample corresponds to at least a 2×magnification and further wherein the magnified image of the selected section of the sample optionally corresponds to a magnification of 4×, 10×, 20×, 40× or 800×. Selecting a section of the first static image is coupled with translating the microscope slide relative to a location for capturing an image of the sample.

### BRIEF DESCRIPTION OF THE DRAWINGS

FIG. 1 illustrates a perspective view of an automated LCM device.

FIG. 2 illustrates a top level block diagram of the components of an automated LCM.

FIG. 3 illustrates a front view (FIG. 3a) and a side view (FIG. 3b) of a cross-section of an automated LCM.

FIG. 4 illustrates a top level block diagram of a cap arm mechanism.

FIG. 5 illustrates a perspective view of a road map camera coupled to a cap transfer system and an automated LCM apparatus.

FIG. 6 illustrates a static roadmap image and a live camera image on a visual display.

FIG. 7 illustrates a selection box on a static roadmap image and the corresponding live camera image on a visual display.

FIG. 8 illustrates effects of magnification of a selection box on a static roadmap image and the corresponding live camera image on a visual display.

FIG. 9 illustrates effects of translation of a selection box on a static roadmap image and the corresponding live camera image on a visual display.

FIG. 10 illustrates a stage navigation tool displayed alongside a static roadmap image and a live camera image on a visual display.

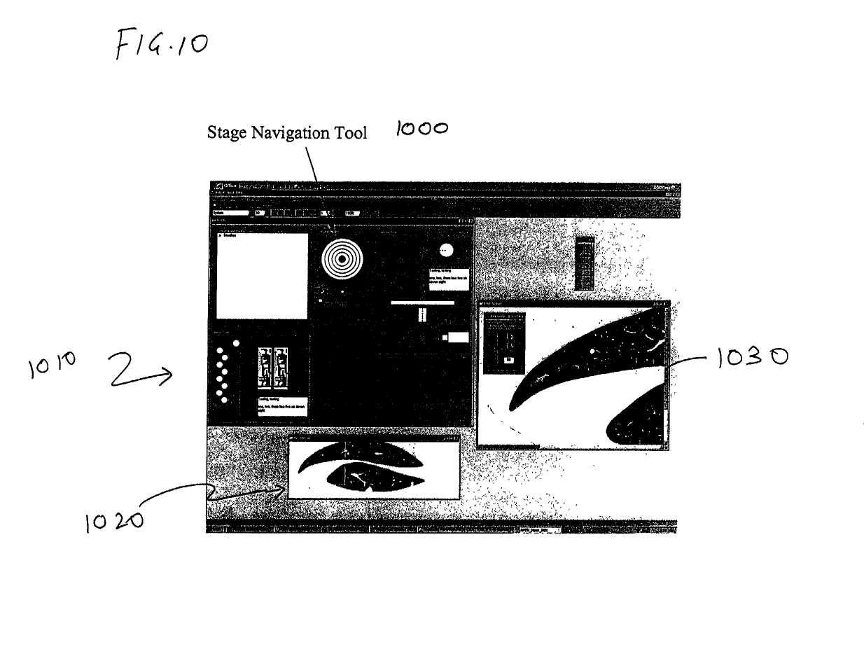

FIG. 11 illustrates controls on a stage navigation tool displayed on a visual display.

While the invention is susceptible to various modifications and alternative forms, specific variations have been shown by way of example in the drawings and will be described herein. However, it should be understood that the invention is not limited to the particular forms disclosed. Rather, the invention is to cover all modifications, equivalents, and alternatives falling within the spirit and scope of the invention as defined by the appended claims.

### DESCRIPTION OF THE INVENTION

The invention and the various features and advantageous details thereof are explained more filly with reference to the nonlimiting embodiments that are illustrated in the accompanying drawings and detailed in the following description. Descriptions of well known components and processing techniques are omitted so as not to unnecessarily obscure the invention in detail.

The entire contents of U.S. Ser. No. 09/018,452, filed Feb. 4, 1998, entitled “Laser Capture Microdissection Device”; U.S. Ser. No. 09/121,691, filed Jul. 23, 1998; U.S. Pat. No. 6,215,550; U.S. Pat. No. 6,184,973; and U.S. Ser. No. 09/121,677, filed Jul. 23, 1998; U.S. Ser. No. 09/617,742, filed Jul. 17, 2000; U.S. Provisional Application No. 60/163,634 filed Nov. 4, 1999; U.S. Provisional Application No. 60/245,884, filed Nov. 3, 2000; and U.S. Ser. No. 09/707,313, filed Nov. 6, 2000 are hereby expressly incorporated by reference into the present application as if fully set forth herein.

A non-automated LCM device operates to carry out the following general steps. A tissue or smear fixed on a standard microscope slide by routine protocols is introduced into an LCM and the tissue is placed adjacent a transfer film carrier cap which further ensures that transfer film stays out of contact with the tissue at this stage. Upon visualizing the tissue by a microscope a user may select a region for microdissection. The selected section of the tissue is captured by pulsing with a low power infrared laser which activates the transfer film which then expands down into contact with the tissue. The desired cell(s) adhere to the transfer film. Microdissection is completed by lifting the film carrier, with the desired cell(s) attached to the film surface while the surrounding tissue remains intact. Extraction and subsequent molecular analysis of the cell contents, DNA, RNA or protein, are then carried out by standard methods.

LCM employs a thermoplastic transfer film that is placed on top of the tissue sample. This film is manufactured containing organic dyes that are chosen to selectively absorb in the near infrared region of the spectrum overlapping the emission region of common AlGaAs laser diodes. When the film is exposed to the focused laser beam the exposed region is heated by the laser and melts, adhering to the tissue in the region that was exposed. The film is then lifted from the tissue and the selected portion of the tissue is removed with the film. Thermoplastic transfer films such as a 100 micron thick ethyl vinyl acetate (EVA) film available from Electroseal Corporation of Pompton Lakes, N.J. (type E540) have been used in LCM applications. The film is chosen due to its low melting point of about 90° C.

The present invention reduces the manual labor and resulting inaccuracies from microdissection by automating several stages of the LCM process. The automation devices of the present invention greatly enhances the efficiency and precision of the process and also enables the execution of microdissection with greater accuracy, speed and sensitivity. High throughput microdissection is provided by using cell procurement and multi-imaging tools for pre-selecting cells of interest. Furthermore, novel methods of computer-controlled cap transfer along with automated multi-slide and multi-cap placements, automated slide and cap detection are provided.

As described in the following descriptions and accompanying diagrams, components involved in the automation include, but are not limited to, automated film carrier cap handling including the ability to process multiple slides simultaneously; automated tissue targeting and microdissection based on fluorescence labeling and image analysis; virtual imaging of a roadmap of the tissue for precise manipulation of the laser capture system which is in turn enhanced by inclusion of a virtual joystick for navigating the virtual roadmap of the tissue; capability of imaging a slide at up to about 1000×magnification including markers or labels on the slide; and software for controlling the manipulation of the various systems.

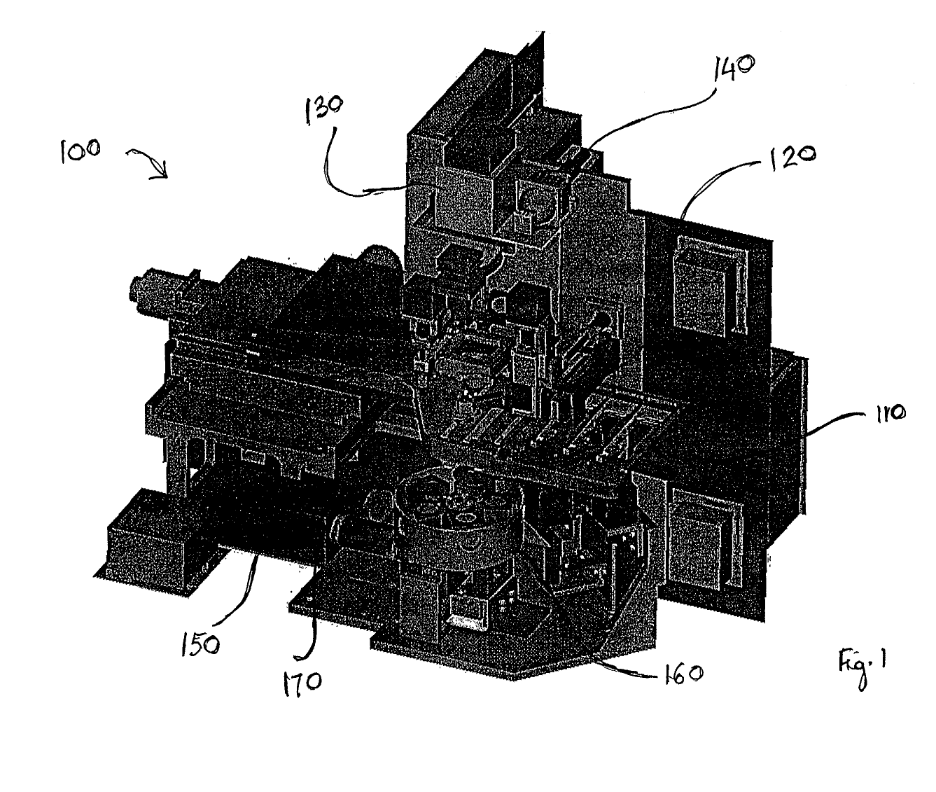

Turning to FIG. 1, a perspective view of an automated LCM device 100 is depicted. The automated LCM device 100 includes a variety of subsystems particularly adapted for the LCM technique which combine to provide synergistic and unexpectedly good results.

A work surface with a motorized translation stage 110 capable of simultaneously handling multiple tissue biopsy slides is coupled to an automated cap handling system 120. An optical train comprising a white light illumination system 130 and a laser source 140 operates to effect the laser guided microdissection. A fluorescent laser source 150 and a fluorescent filter wheel system 160 implements a fluorescent-detected tissue image analysis system which comprises one embodiment of the automated LCM process. In the depicted embodiment, a black-and-white and/or color camera housing system 170 generates static roadmap and live images of the tissue sample for added controllability during the LCM process. The road image capture and manipulation mechanisms are discussed in further detail in a following section.

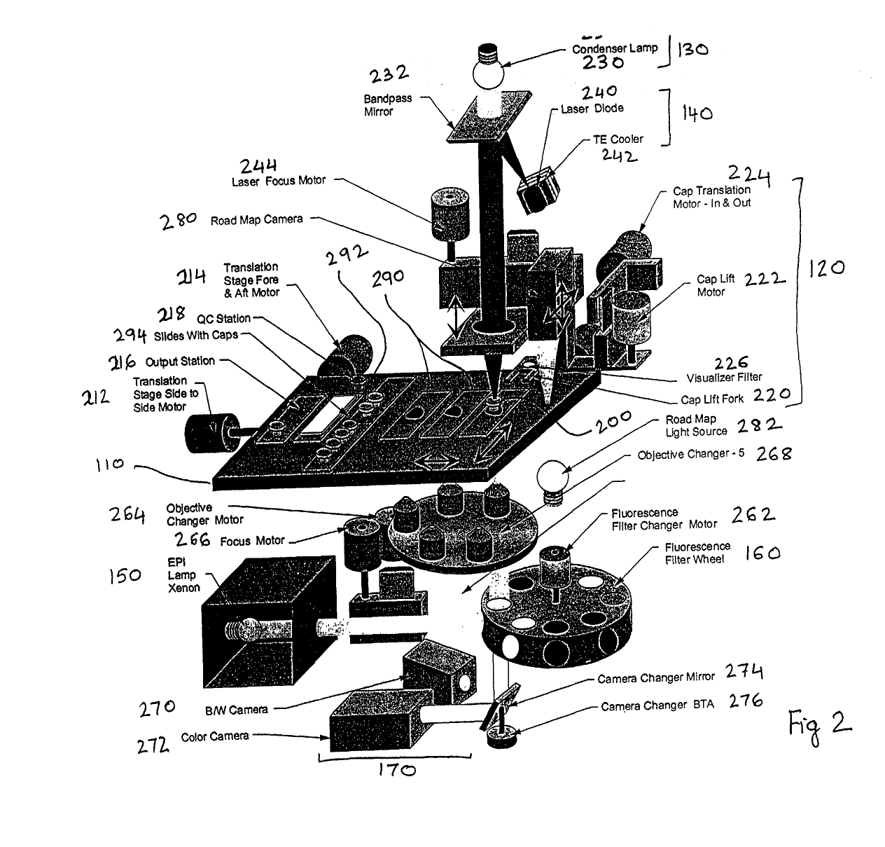

Turning now to FIG. 2, a top level block diagram of the components of an automated LCM and an embodiment of the relative arrangement of various novel parts of the system is depicted. The work surface 110 includes a translation stage to allow manipulation in an X-Y plane by a lateral translation motor 212 and a fore-and-aft translation motor 214. The work surface 110 also includes an output station 216 and a quality control station 218. One or more slides 290 of tissue samples can be simultaneously processed on a work surface 110 which may also include slides 294 which serve as staging areas for caps 292.

A cap transfer mechanism subassembly 120 is coupled to the work surface 110 and comprises a cap translation motor 224 which operates to move a cap lift fork 220 in and out of the work surface 110. The cap transfer system 120 also includes a visualizer filter 226 and a cap lift motor 222. The visualizer is a piece of diffuser glass positioned above tissue sample. The light from above is diffused by the visualizer 226 illuminating the sample from all angles from above. This high illumination angle or high NA (Numerical Aperture) illumination provides optimal image quality. The visualizer 226 can be moved in and out of position and is located on the cap arm.

In general, any suitable scattering media can be used to provide the finctions of the visualizer 226. Providing such a scattering media near the tissue to scatter the light results in dramatically improved illumination of the sample and much better visualization. A scattering media of this type eliminates the need for refractive index matching of the sample. Such a scattering media can allow visualization of the cell nucleus and other subcellular structures that would normally be obscured by normal illumination techniques. The scattering media can be a diffuser material. A diffuser material that is suitable for use as the scattering media is milk or opal glass which is a very dense, fine diffuser material. For instance, a suitable milk glass is available from Edmund Scientific as Part No. P43,717. Standard laser printer/photocopier paper can even be used as the scattering media. Other types of transparent scattering media can be used, such as, for example, frosted glass, a lenticular sheet, a volume diffuser, and/or a surface diffuser. In any event, the scattering media should be a material that aggressively scatters the illumination light. A single sheet of typical ground glass is generally inadequate and needs to be combined in multiple layers as a serial stack of three or four sheets of ground glass to diffuse the illumination light sufficiently. can be directly or indirectly connected to the transfer film carrier and/or the LCM transfer film. Alternatively, the visualizer 226 can be formed on a surface of, or the interior of, the transfer film carrier and/or the LCM transfer film. The scattering media can be fabricated so as to shape the LCM beam and/or the illumination beam. The scattering media needs to be within a few millimeters of the sample to be effective. A few millimeters means less than one centimeter, preferably less than five millimeters.

The cap transfer mechanism subassembly 120 provides a structure for picking a microcentrifuge tube cap 292 from a supply 294 and placing the microcentrifuge tube cap 292 on top of a tissue sample on a slide 290 that is to undergo LCM. In the depicted embodiment, the microcentrifuge tube cap 292 is a cylindrical symmetric plastic cap and the supply 294 includes four consumables per slide 294. In the depicted embodiment, there is a laser capture microdissection transfer film coupled to the bottom of the microcentrifuge tube cap 120. The movement of the cap handling mechanism subassembly 120 is described in greater detail in a separate section.

A glass slide 290 to which the sample to be microdissected is fixed and upon which the microcentrifuge tube cap 292 is placed, is located in the primary optical axis of the automated LCM 100. In alternative embodiments, the slide that supports the sample can be made of other substantially transparent materials, for example, plastics such as polycarbonate. The glass slide 290 may be supported and held in place by a vacuum chuck (not shown). The vacuum chuck is a substantially flat surface that engages the glass slide 290 through a manifold (not shown) so as to hold the glass slide 290 in place while the microcentrifuge tube cap 120 is picked and placed and while the work surface 110 is manipulated in an X-Y plane.

The optical train comprises a white light illumination system 130 which is comprised of a condenser lamp 230 and a bandpass dichroic mirror 232. White light from the illuminator 230 passes downward toward the microcentrifuge tube cap 200 through a dichroic mirror 232 and a focusing lens (not shown). Also coupled to the optical train is a laser beam system 140 comprising a thermoelectric cooled 242 laser diode 240 with collimating optics emits a beam that is incident upon the dichroic mirror 232. The bandpass mirror 232 is a dichroic that reflects the beam downward through the focusing lens toward the microcentrifuge tube cap 200. Simultaneously, the dichroic mirror 232 allows white light from the illuminator 230 to pass directly down through the focusing lens toward the microcentrifuge tube cap 200. Thus, the laser beam and the white light illumination are superimposed. A laser focus motor 244 operates to control the focusing lens and adjust the laser beam spot size.

A schematic diagram of another component of an instrument according to the invention is depicted in FIG. 2. In this embodiment, a light source 150 (e.g., a fluorescence laser generated by an EPI/fluorescent xenon or mercury lamp), emits a specific wavelength or wavelength range. The specific wavelength or wavelength range of a beam emitted by the light source 150 is selected by a fluorescence filter wheel operated by a fluorescence filter changer motor 262, to excite a fluorescent system (e.g., chemical markers and optical filtering techniques that are known in the industry) that is incorporated in or applied to the sample to be microdissected. The frequency of the beam emitted by the fluorescence laser 150 can be tuned. The sample includes at least one member selected from the group consisting of chromophores and fluorescent dyes (synthetic or organic), and the process of operating the instrument includes identifying at least a portion of the sample with light that excites at least one member, before the step of transferring a portion of the sample to the laser capture microdissection transfer film. The fluorescent laser beam can be made coincident or coaxial with both the laser 240 beam path and the white light from illuminator 230 path. Fluorescence emitted by the sample beneath the microcentrifuge tube cap 200 is amplified (optionally) by an objective changer 268, reflected by a camera changer mirror and captured for “live” viewing by a camera system 170 which comprises a black-and-white camera 270 and/or a color camera 272. An objective changer motor 264 and a focus motor 266 operate to adjust the fluorescent laser beam and the emitted fluorescent beam. Optionally the objective changer may be implemented in the form of a wheel 268 to accommodate a multiplicity of objectives (five objectives, as depicted) for providing different amplifications of the fluorescent image for the cameras.

A road map camera system 280 is coupled to the work surface 110 and the cap transfer mechanism subassembly 120, and operates to provide an image of the tissue sample on the slide 290. In one embodiment, the road map camera 280 is mounted in a stationary position and the work surface 110 is translated to capture the roadmap image. In an alternate embodiment, the road map camera 280 is capable of translation to scan or otherwise provide an image of the tissue illuminated by a light source 282. Since the translation of the roadmap camera is coupled to the work surface 110, it allows for precise alignment of a selected section of the roadmap image to be brought into the path of the laser 240 beam. The section selected by a viewer of the road map image may be further viewed in an amplified form by a “live” viewer of the camera system 170 by selecting an appropriate objective from the objective changer 268 following alignment of the selected roadmap image to the fluorescent laser. The roadmap camera can include variable objectives resulting in magnifications of 4×, 10×, 20×, 40×and upto 800×.

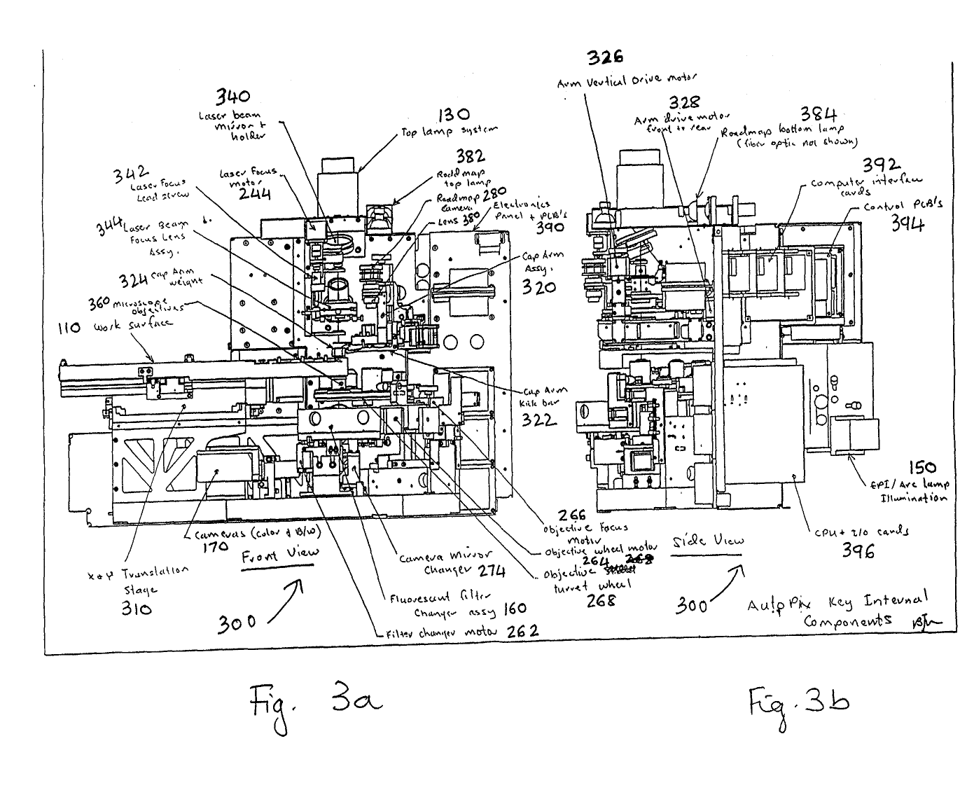

Turning now to FIG. 3, a front view (FIG. 3a) and a side view (FIG. 3b) of a cross-section of a depicted embodiment of an automated LCM are illustrated. An X-Y translation stage is coupled to the working surface 110. Further details of the cap transfer mechanism subassembly 120 are revealed including a cap arm assembly 320 comprising a cap arm kick bar 322 which operates a cap fork for transportation and operation of a cap and a cap arm weight 324 which operates to position the LCM film bearing cap on the sample as well as to insert a cap into a microfuge tube or other consumable. Drive motors manipulate a cap arm vertically 326 and laterally 328 as depicted in FIG. 3b.

A laser beam focus lens assembly 344 operates to focus the LCM laser beam on the target sample slide and is manipulated by a laser focus lead screw 342 which is in turn adjusted by a laser focus motor 244. In idle mode, the laser beam path provides a visible low amplitude signal that can be detected via the image acquisition camera system 170 when a visual alignment is desired. In pulse mode, the laser beam path delivers energy to the microcentrifuge tube cap 200 and the optical characteristics of a cut-off filter attenuate the laser beam path sufficiently such that substantially none of the energy from the laser beam exits through the microscope.

Suitable laser pulse widths are from 0 to approximately 1 second, preferably from 0 to approximately 100 milliseconds, more preferably approximately 50 milliseconds. In a preferred embodiment the wavelength of the laser is 810 nanometers. In a preferred embodiment the spot size of the laser at the EVA material located on microcentrifuge tube cap 120 is variable from 0.1 to 100 microns, preferably from 1 to 60 microns, more preferably from 5 to 30 microns. These ranges are relatively preferred when designing the optical subsystem. From the standpoint of the clinical operator, the widest spot size range is the most versatile. A lower end point in the spot size range on the order of 5 microns is useful for transferring single cells.

Suitable lasers can be selected from a wide power range. For example, a 100 watt laser can be used. On the other hand, a 50 mW laser can be used. The laser can be connected to the rest of the optical subsystem with a fiber optical coupling. Smaller spot sizes are obtainable using diffraction limited laser diodes and/or single mode fiber optics. Single mode fiber allows a diffraction limited beam.

While the laser diode can be run in a standard mode such as TEM₀₀, other intensity profiles can be used for different types of applications. Further, the beam diameter could be changed with a stepped lens in the lens assembly 344.

Changing the beam diameter permits the size of the portion of the sample that is acquired to be adjusted. Given a tightly focused initial condition, the beam size can be increased by defocusing. Given a defocused initial condition, the beam size can be decreased by focusing. The change in focus can be in fixed amounts. The change in focus can be obtained by means of indents on a movable lens mounting and/or by means of optical glass steps. In any event, increasing/decreasing the optical path length is the effect that is needed to alter the focus of the beam, thereby altering the spot size. For example, inserting a stepped glass prism into the beam so the beam strikes one step tread will change the optical path length and alter the spot size.

A series of microscope objectives 360 may be selectably deployed from an objective turret wheel 268 which is controlled by an objective wheel motor 264 while a second objective focus motor 266 operates to adjust the foci of objectives which have been positioned.

The road map camera 280 operates by one or more adjustable lens 380 and may include one or more of a top lamp 382 and a bottom lamp 384. The road map camera requires illumination from the top and the bottom for optimum imaging. The top illumination 382 is needed to illuminate identity markings on the slide. Typically a stick-on label is placed on one end of a slide and the label is marked with a pen and/or has a bar code printed on it. The top light source is used when the camera is over this portion of the slide. Optionally, a fiber optic is used to deliver light from the bottom of the slide. The bottom illumination 384 is used when the roadmap camera 280 is imaging tissue samples. The top and bottom light controls are independently adjustable in one embodiment.

An electronics panel 390 comprises printed circuit boards 394 for controlling mechanisms and instructions for the automated LCM, computer interface cards 392 and I/O devices 396 for communicating with a couples central processing unit may be assembled as part of the automated LCM unit 300.

Automated Fluorescent Microscopy

The procedure of selecting cells or specific regions of a sample for microdissection can be further automated by using fluorescently-stained cells. In image analysis, the labeled tissue is presented to an automated microscope on a solid substrate and the cells are detected through an analysis of the image formed by the microscope. Typically, the image is scanned with a small laser spot to excite the fluorescent molecules. The visual examination of the sample spread over a solid support with a microscope is a tedious, time consuming process. It is complicated by the presence of other fluorescent material. When searching abnormal cells with a microscope, a large surface has to be viewed, and the risk of missing one abnormal cell is high. The utilization of confocal microscopy or image analysis using fluorescent dyes permits the automated detection of the rare abnormal cells.

A rare cell of interest can be detected or identified on the basis of its morphological, biochemical, genetic, or other characteristics. Histochemical staining is especially useful for identification of a rare cell of interest. Imnunological labeling is another method that can be used to identify a cell of interest. According to this technique, an antibody specific for an antigen whose presence (or absence) is characteristic of a rare cell of interest is bound to the cell and directly or indirectly labeled with a fluorescent stain. Immunolabeling techniques are well known and are described generally in Harlow and Lane, Antibodies: A Laboratory Manual, Cold Spring Harbor, N.Y. (1988), which is incorporated herein by reference.

The cell can be identified based on the density of stain resulting from a fluoresence-conjugated stain or by immunohistochemical methods using fluorescently-labeled antibodies. Cells extracted and stained in this manner are usually viewed using a microscope fitted with an appropriately colored filter. However detected, the location of the cell of interest on the support (e.g., slide) is determined and recorded.

In one aspect of the present invention, the cell is located on the slide by scanning an analyzed image and identifying the points of denser fluorescent label relative to the overall sample. This process is automated by a using a controller which scans the fluorescent sample and determines the positions (stage coordinates) of the cells or tissue section of note. In one embodiment, an automated microscope is used. In this embodiment, the microscope is equipped with a motorized stage, a computer based image analysis system (including algorithms for automated focusing and cell detection), and a means for storing the location (i.e., coordinates on the slide) of an identified rare cell, so that cells of interest can be precisely relocated. An example of an automated microscopes that includes a motorized stage is the LSC microscope (CompuCyte Corp., Cambridge, Mass.). A typical embodiment of the automated navigation system according the invention comprises a fluorescent microscope, an automated XY stage, three chip color CCD camera and appropriate software. In another embodiment, the automated microscope may be replaced by an image scanner which records and analyzes a image of the slide to determine the coordinates of the cells of interest and then directs a controller to operate the microdissection process at the specified sites. In brief, the coordinates of a tissue section of interest are mapped by a controller after gathering data from the image capture system 170 the laser beam is aligned with the selected tissue section in reference to the coordinates of the translational stage 310 of the working surface 110. The size of tissue sections to be microdissected is preset in a totally automated system or may be selected by adjusting the focal characteristics of the laser beam.

The image analysis software typically includes a means for distinguishing a cell of interest from other cells in the population (e.g., by evaluation of the shape and size of the nucleus and cytoplasm, differential evaluation of images taken using different filters that reveal differences in cell staining) and for recording the location of the cell in the slide.

Techniques have been reported for the fluorescent visualization of molecules and complexes. Such techniques include such fluorescence microscopy-based techniques as fluorescence in situ hybridization (FISH; Manuelidis, L. et al., 1982, J. Cell. Biol. 95:619; Lawrence, C. A. et al., 1988, Cell 52:51; Lichter, P. et al., 1990, Science 247:64; Heng, H. H. Q et al., 1992, Proc. Natl. Acad. Sci. U.S.A. 89:9509; van den Engh, G. et al., 1992, Science 257:1410). Fluorescence in situ hybridization refers to a nucleic acid hybridization technique which employs a fluorophor-labeled probe to specifically hybridize to and thereby, facilitate visualization of, a target nucleic acid. Such methods are well known to those of ordinary skill in the art and are disclosed, for example, in U.S. Pat. No. 5,225,326; U.S. patent application Ser. No. 07/668,75 1; PCT WO 94/02646, the entire contents of which are incorporated herein by reference. In general, in situ hybridization is useful for determining the distribution of a nucleic acid in a nucleic acid-containing sample such as is contained in, for example, tissues at the single cell level. Briefly, fluorescence in situ hybridization involves fixing the sample to a solid support and preserving the structural integrity of the components contained therein by contacting the sample with a medium containing at least a precipitating agent and/or a cross-linking agent. Alternative fixatives are well known to those of ordinary skill in the art.

A xenon or argon laser can be used to produce multiple lines for fluorescence excitation. A 355line is useful for excitation of compounds such as DAPI and indo-1, while probes excited by a 488 line include FITC, phycoerythrin, and fluo-3. A wide variety of fluorescent probes and antibodies are available commercially. The Molecular Probes web site (www.probes.com) list a large number and Becton Dickinson (www.bdfacs.com) is a good resource for fluorescent antibodies.

Selection of Tissue Section

A slide carrying a fluorescently labeled tissue sample 290 is positioned on the working surface 110. The translation stage 310 operates to position the slide at a location for the performance of automated LCM. A controller (not shown) determines the X-Y coordinates (x, y) of the position of the slide. Confocal laser, fluorescence and illumination beams of the apparatus are aligned to pass through the same x, y coordinates on the working surface.

Optionally, the slide is first brought into alignment with a roadmap camera 280 by translating the x, y coordinates of the working surface into alignment with the focal plane and axis of the roadmap camera 280 and an image of the entire tissue sample is captured for reference. Image capture by the roadmap camera is aided by one or more lamps 382 and 384.

The slide is then aligned with the confocal axis of the illumination lamp 130 and the laser beam from the laser diode 240. The beam from the EPI/fluorescent lamp 150 is also aligned with the same optical axis to generate the fluorescent excitation of the tissue sample on the slide 290. A fluorescent filter wheel 160 may be used to select different lines for selective excitation of different fluorescent dyes used on a sample. The entire tissue sample or specific parts of it can be selectively excited by selecting different lenses of one or more objectives from an objective turret wheel 268.

A camera mirror 274 also aligned along the same optical axis reflects a “live” image of the illuminated fluorescent tissue and allows the capture of the “live” image in a black and white 270 or color 272 camera. A color CCD camera 272 is additionally able to distinguish different chrominance values resulting from different colored fluorescent emanations.

The “live” fluorescent image captured by the camera system 170 may be read automatically or displayed in the screen of a video terminal for precise selection of tissue sections of interest.

A typical embodiment of the fully automated navigation system according the invention comprises an image scanner and appropriate software. The x, y coordinates of a tissue section of interest (e.g., marked by enhanced fluorescence) are mapped by a controller after gathering scanned data from the image capture system 170. The automated cap transfer system, which is also coupled to the working surface 110, then positions a cap at the selected x, y coordinates of the working surface 110 in alignment with the laser beam. The translational stage 310 operates to align first the roadmap camera 280, and then the cap transfer system 120. A microprocessor implements the functions of the automated LCM for selecting tissue sections based on enhanced fluorescence. The x, y coordinates of a tissue section exhibiting enhanced fluorescence are recorded on a memory module and elements of the automated LCM apparatus such as the cap transfer arm and laser capture beam are aligned according to the recorded x, y coordinates. The microprocessor comprises a digital microprocessor or similar controller devices and other electronics such as display drivers and graphics chips necessary for controlling the automated LCM via an optional video display screen when additional control of the tissue section selection process is desired. The size of tissue sections to be microdissected may be preset in a totally automated system or may be manually selected by adjusting the focal characteristics of the laser beam. One or more image analysis softwares included in a memory of the microprocessor system typically includes instructions for distinguishing a cell of interest from other cells in the population (e.g., by evaluation of the shape and size of the nucleus and cytoplasm, differential evaluation of images taken using different filters that reveal differences in cell staining) and for recording the location of the cell in the slide.

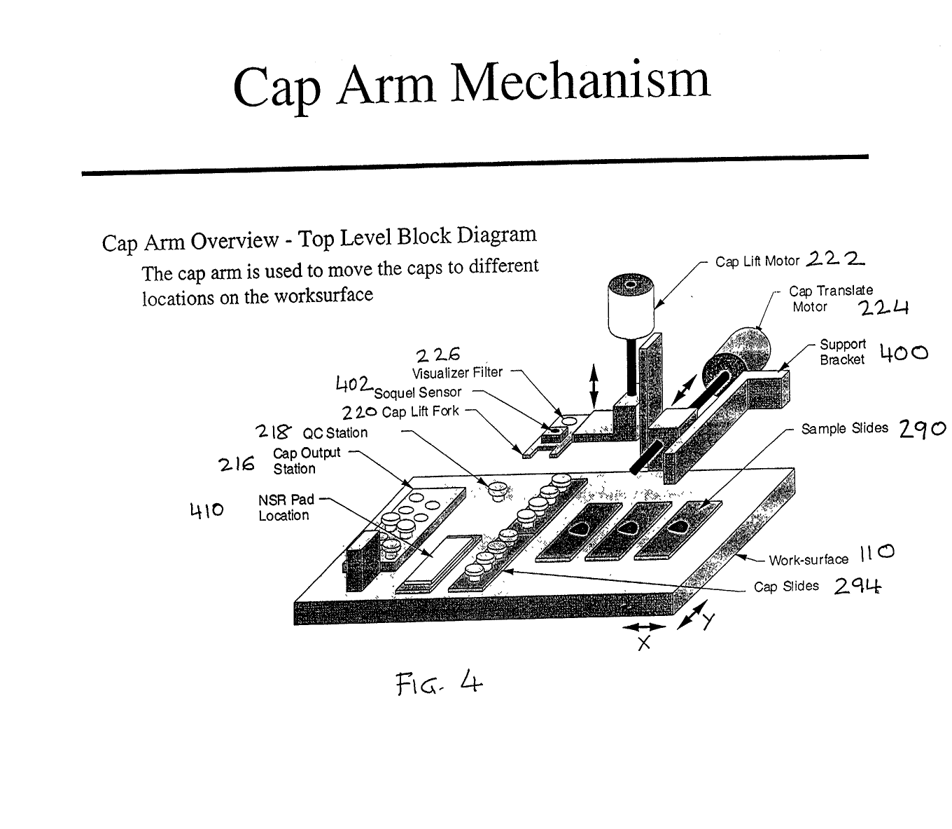

A cap arm mechanism, as illustrated in a top level block diagram in FIG. 4, is used to move the caps to different locations on the work surface. The automated LCM is able to manipulate cap arms and process multiple sample slides in a single pass.

The cap arm transfer subsystem is mounted on a support bracket 400. A cap lift motor 222 operates to lift the cap arm lift fork 220 vertically with respect to the working surface 110. A cap translation motor 224 operates to move the cap lift fork 220 horizontally over the working surface 110.

A sensor 402 is a sensor located on the cap arm and used to detect different materials and/or disposables loaded into the instrument. The sensor 402 detects optical phase changes and is used to detect the presence, or absence, of caps in the loading station, tissues slides 290, caps in the QC station 218, and caps in the output station 216. The sensor 402 is accurate at making measurements in the micron range and may be coupled with optical systems to enhance the accuracy of focusing the objectives and the laser beam.

In an embodiment, the cap lift fork is moved by the cap translation motor 224 over a cap supple slide 292 on the working surface 110 to engage a cap and lifted up by a cap lift motor 222 with the cap engaged to the fork. The translation stage operates to move the working surface 110 along a horizontal plane, such that the cap is positioned over a selected section of the tissue sample slide 290. The cap lift motor 222 then operates to lower the cap to a designated site on the sample slide 290 and the cap translation motor 222 then operates to withdraw the cap lift fork 220 thereby disengaging the cap from the fork and leaving the cap in place over the selected tissue for performance of LCM. Multiple caps may be positioned on a slide corresponding to one or more LCM sites on a tissue slide.

Following LCM, the cap transfer system picks up a cap from a tissue slide and translates it to a QC station 218. A QC station 218 is a physical location on the work surface 110 where the cap can be placed for inspection purposes. An image file (tiff or jpeg) of the cells that were collected on the cap may be archived. Quantity of cells captured or “QC” may be performed to confirm the number of cells transferred or “captured” are within an acceptable fraction of the cells targeted. They can also look for and record any unwanted cells. A Non-Specific Removal (NSR) pad 410 may be optionally deployed as a means of removing non-specific or unwanted cells from the transfer film on the cap. The cap transfer system finally picks up the cap from the QC station 218 and transfers it to the output station 216.

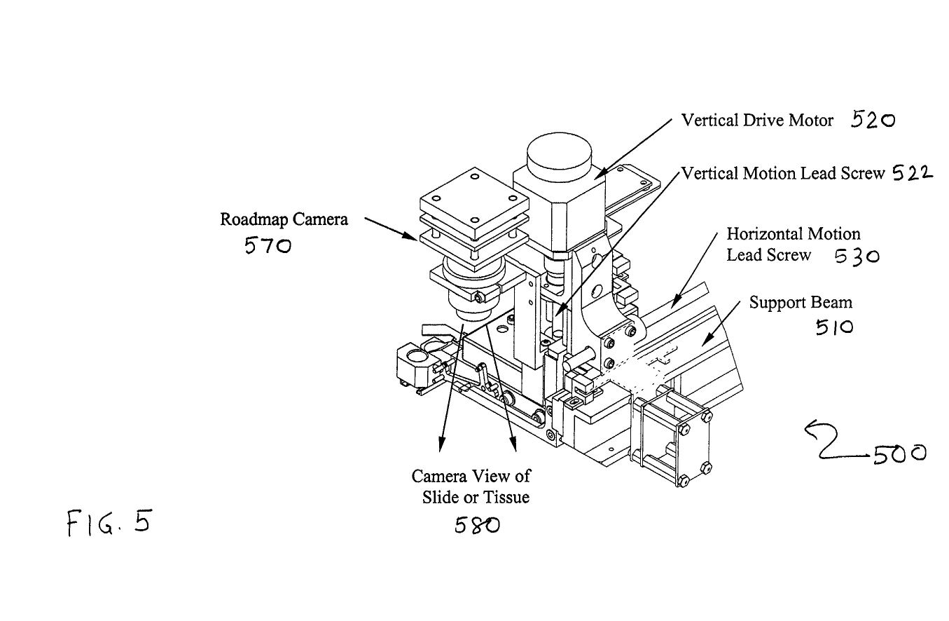

Turning now to FIG. 5, a perspective view of a cap transfer system 500 is depicted. The cap transfer system is mounted on a support beam 510 which in turn couples the cap transfer system to the LCM apparatus. A vertical drive motor 520 drives a vertical motion lead screw 522 to operate the lifting and lowering of the cap transfer system over the working surface. A cap translation motor (not shown in this figure) drives a horizontal motion lead screw 530 to operate a horizontal motion of the cap transfer system above the work surface as required for the translocation of caps.

Road Map Image Guide

Staying with FIG. 5, a road map camera 570 is mounted on the support beam 510 thereby coupling the road map camera 570 to the LCM apparatus. The road map camera view of the slide or tissue 580 is used to determine the x.y coordinates of the section of interest on the slide. The slide is first brought into alignment with a roadmap camera 570 by translating the x, y coordinates of the working surface into alignment with the focal plane and axis of the roadmap camera 570 and an image of the entire tissue sample is captured for reference.

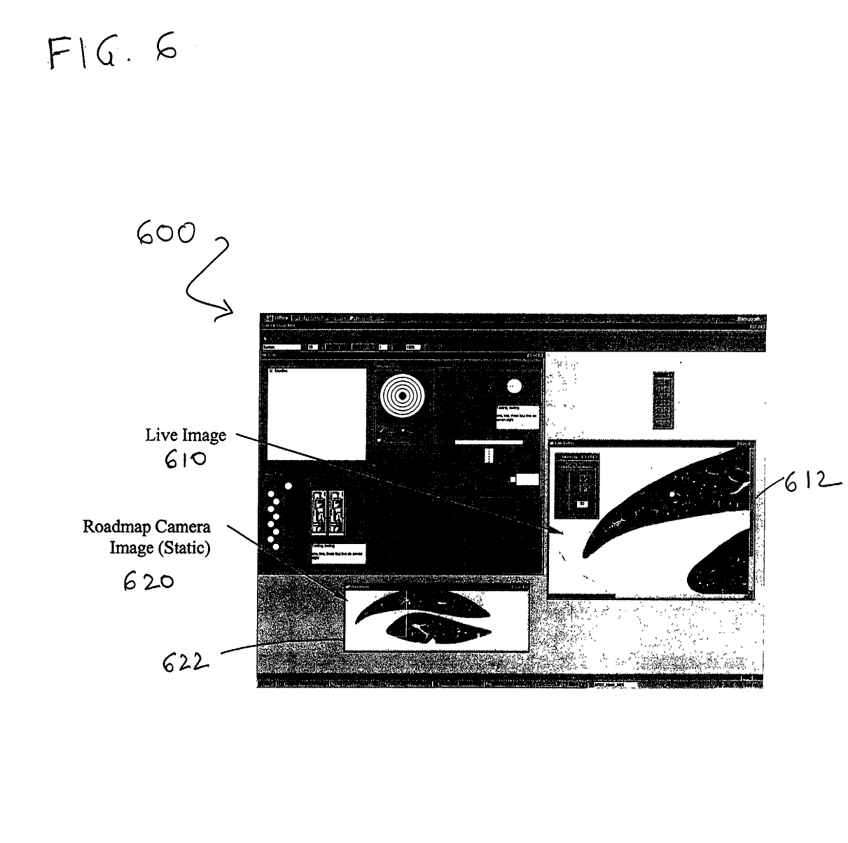

FIG. 6 illustrates a roadmap image 620 obtained by a roadmap camera as viewed in a video display 600 coupled to a computer (not shown). The roadmap camera generates a static image 620 in a first window 622. The static roadmap image provides a snapshot of the full slide and acts as a reference image in navigation using a live image capture mechanism. Optionally, image capture of the entire tissue sample by the roadmap camera may be carried out by separately imaging sections of the tissue sample and subsequently reconstructing the entire tissue sample by generating a geometrically corrected, single “stitched” image. On example of a method for generating a composite image by stitching together partial images is disclosed in U.S. Pat. No. 6,133,943 which is incorporated herein in its entirety by reference. The stitched image of the entire tissue sample is then displayed as the static image 620 in the first window 622.

Manipulating the camera creates a live image 610 in a second window 612 on the display which displays, in real time, the actual position of the camera and any other coupled devices such as a laser. In one embodiment the static reference image 620 in the first window 622 is captured using a low resolution image capture mechanism (e.g., camera) and the second live image 610 displayed in the second window 612 is captured using a high resolution image capture mechanism.

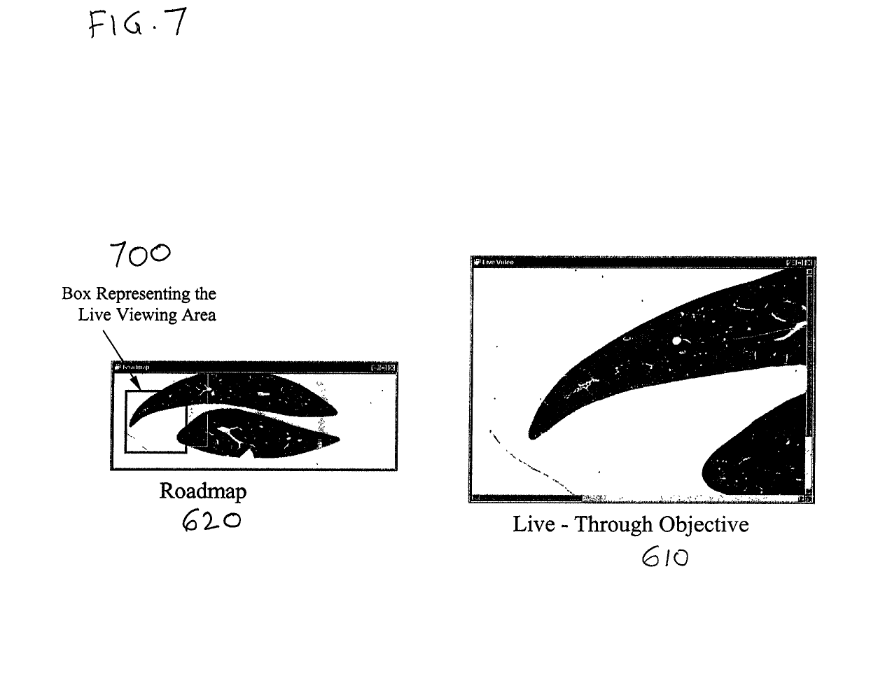

The roadmap camera can include variable objectives resulting in magnifications of 4×, 10×, 20×, 40× and upto 800×. As shown in FIG. 7, a box 700 on the static image defines the area of the sample displayed in the live image window. The position of the box 700 can be manipulated on the road map image 620 to specify the location on the live image 610. Optionally, such navigation is carried out by a stage navigation tool described in a following section.

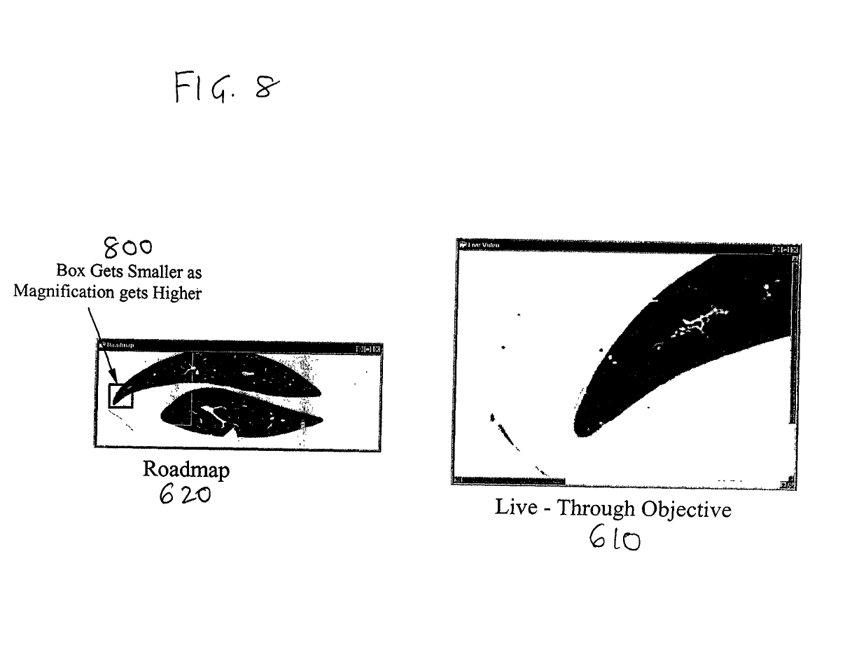

The road map image display is coupled to the image captured by magnification optics on the road map camera. As shown in FIG. 8, the size of the box 800 on the road map image 620 is inversely proportional to the magnification selected for the live image capture mechanism such as the road map camera.

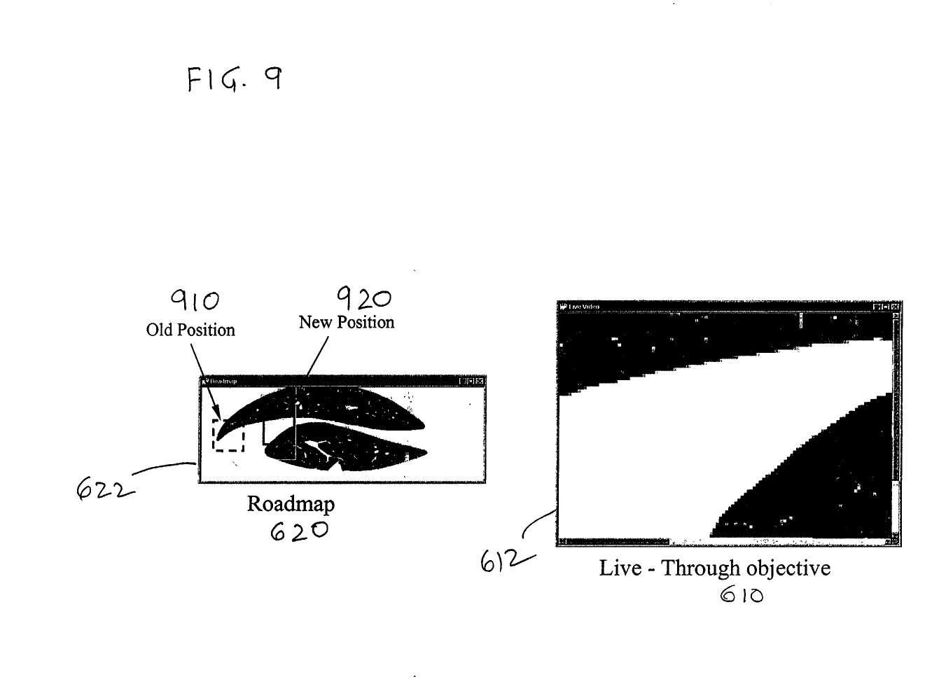

The location of the live image 610 can be specified by coupling the positioning of the roadmap camera to the translation of the image selection box in the road map window 622. As shown in FIG. 9, moving the image selection box from a first position 910 to a second position 920 in the roadmap window 622 causes the roadmap camera and the work station carrying the tissue slide to translate with respect to each other and position the road map camera such that a live image 610 corresponding to the new position 920 of the box is displayed in the live image window 612. The movement of the box can optionally be accomplished directly on the roadmap window 620 by use of a computer mouse. Other means can also be used to move the live image. The box on the screen moves dynamically and is coupled to the live image as described.

Stage Navigation Control

Stage Navigation includes several controls which can be used to navigate the road map image by either moving the tissue slide or moving the objectives with respect to the live image. The stage navigation is optionally operated by a toolbar 1000 displayed on a video terminal 1010 and controlled by a microprocessor. The video display is preferably a high resolution monitor having a resolution of 1024×780 or higher. Compatibility with standard computer operating systems such as Microsoft Windows is preferred. The video display may simultaneously display the navigation toolbar 1000, the roadmap image 1020 and the live image 1030. Video controls for stage tools and other mechanisms for selecting and aligning may also be displayed on the video terminal 1010.

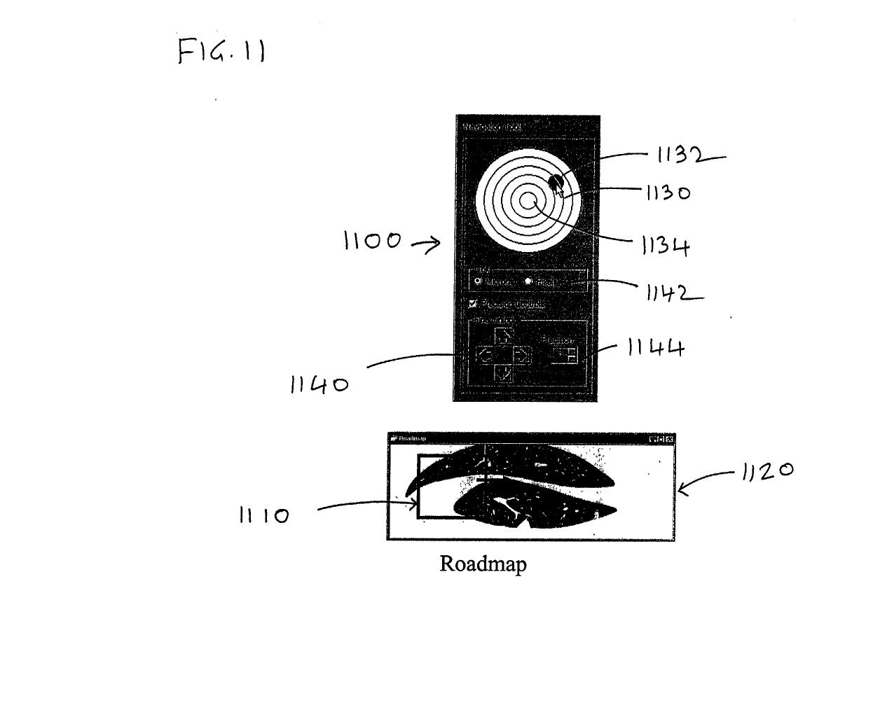

One embodiment representative of a navigational toolbar is illustrated in FIG. 11 and represents a versatile virtual joystick 1100 which allows the user to move the box 1110 selecting the live video region around the slide with “fine tuning” buttons. A typical procedure involves clicking a cursor 1130 on the black dot 1132 to select the joystick 1100 and then moving the dot 1132 from the target center 1134 to create motion. The direction the dots move determines the direction of image box 1110 movement, and the magnitude of the motion is increased as the distance from the center is increased. Releasing the button on the mouse and deselecting the cursor stops motion.

The virtual joystick 1100 can be optionally controlled with precision control arrows 1140 which control movement of the box in any direction at precise distances. Units 1142, such as microns and pixels, and increments 1144 (e.g., 1, 5, 10 microns, etc.) of movement of the selection box 1110 per click on an arrow 1140 can be selected.

Automated Navigation

The procedure of selecting cells or specific regions of a sample for microdissection can be further automated by microdissecting fluorescently-stained cells. An optional fluorescence package includes a high-sensitivity variable integration time color CCD video camera and red, blue and green filter cubes.

A rare cell of interest can be detected or identified on the basis of its morphological, biochemical, genetic, or other characteristics. Histochemical staining is especially useful for identification of a rare cell of interest. Immunological labeling is another method that can be used to identify a cell of interest. According to this technique, an antibody specific for an antigen whose presence (or absence) is characteristic of a rare cell of interest is bound to the cell and directly or indirectly labeled with a fluorescent stain. Immunolabeling techniques are well known and are described generally in Harlow and Lane, Antibodies: A Laboratory Manual, Cold Spring Harbor, N.Y. (1988), which is incorporated in its entirety herein by reference.

The cell can be identified based on the density of staining, the shape and size of the nucleus and cytoplasm, or other by immunohistochemical methods. Cells extracted and stained in this manner are usually viewed using a microscope fitted with an appropriately colored filter. However detected, the location of the cell of interest on the support (e.g., slide) is determined and recorded.

In one aspect of the present invention, the cell is located on the slide by scanning an image and identifying the points of denser fluorescent label relative to the overall sample. This process is automated by a using a controller which scans the stained sample and determines the positions (stage coordinates) of the cells or tissue section of note. In one embodiment, an automated microscope is used. In this embodiment, the microscope is equipped with a motorized stage, a computer based image analysis system (including algorithms for automated focusing and cell detection), and a means for storing the location (i.e., coordinates on the slide) of an identified rare cell, so that cells of interest can be precisely relocated. An example of an automated microscopes that includes a motorized stage is the LSC microscope (CompuCyte Corp., Cambridge, Mass.). In another embodiment, the automated microscope may be replaced by an image scanner which records and analyzes a image of the slide to determine the coordinates of the cells of interest and then directs a controller to operate the microdissection process at the specified sites.

The image analysis software typically includes a means for distinguishing a cell of interest from other cells in the population (e.g., by evaluation of the shape and size of the nucleus and cytoplasm, differential evaluation of images taken using different filters that reveal differences in cell staining) and for recording the location of the cell in the slide.

All publications and patent applications mentioned in this specification are incorporated herein by reference to the same extent as if each individual publication or patent application were specifically and individually indicated to be incorporated by reference.

The above description is illustrative and not restrictive. Many variations will be apparent to those skilled in the art upon review of this disclosure. The scope of the invention should not be determined with reference to the above description, but instead should be determined with reference to the appended claims and the full scope of their equivalents.

What is claimed is:

1. A road map camera system for capturing an image of a sample in a microscopy apparatus, wherein the microscopy apparatus comprises a work surface comprising at least one sample, the system comprising:
a road map camera comprising an objective lens, coupled to the work surface such that the road map camera and the work surface are able to translate in two dimensions relative to each other;
at least one light source to illuminate the sample; and
a system to display an image captured by the camera.

2. The road map camera system of claim 1, wherein the microscopy apparatus is a microdissection apparatus.

3. The road map camera system of claim 1, wherein the microscopy apparatus is a laser capture microdissection (LCM) apparatus.

4. The road map camera system of claim 1, wherein the objective lens has a magnification of at least 2×.

5. The road map camera system of claim 4, wherein the objective lens has a magnification of 4×, 10×, 20×, 40× or 800×.

6. The road map camera system of claim 1, wherein the at least one light source illuminates the top of the sample.

7. The road map camera system of claim 6, wherein illumination from the top illuminates one or more identity markings on a microscopy slide carrying the sample.

8. The road map camera system of claim 1, wherein the at least one light source illuminates the bottom of the sample.

9. The road map camera system of claim 8, wherein the a fiber optic light source illuminates the bottom of the sample.

10. The road map camera system of claim 1, wherein a first light source illuminates the top and a second light source illuminates the bottom of the sample.

11. The road map camera system of claim 10, wherein the first and second light sources are independently adjustable.

12. The road map camera system of claim 3, wherein the microdissection apparatus further comprises a cap transfer mechanism subassembly and the road map camera is coupled to the cap transfer mechanism subassembly.

13. The road map camera system of claim 1, wherein the road map camera is stationary and the work surface is translatable.

14. The road map camera system of claim 1, wherein the road map camera is translatable and the work surface is stationary.

15. A road map image guiding system for a microscopy apparatus, the system comprising:
a sample on a microscope work surface;
at least one image capture mechanism for capturing at least one image of the sample;
a video display for displaying the captured image;
means for displaying on the video display a static first captured reference image within a first display window;
means for selecting a section of the first reference image; and
means for displaying a second live captured image within a second display window wherein the second live captured image corresponds to the selected section of the first captured reference image.

16. The road map camera system of claim 15, wherein the microscopy apparatus is a microdissection apparatus.

17. The road map camera system of claim 15, wherein the microscopy apparatus is a laser capture microdissection (LCM) apparatus.

18. The system of claim 15, wherein selection of a section of the first captured reference image is coupled to the image capture mechanism for capturing a live image of the sample.

19. The system of claim 15, wherein the first captured reference image is captured using a low resolution image capture mechanism and the second live captured image is captured using a high resolution image capture mechanism.

20. The system of claim 18, wherein the image capture mechanism is a camera.

21. The system of claim 15, wherein the video display is a high resolution video display.

22. The system of claim 15, wherein the means for selecting and displaying the images on the video display are controlled by at least one microprocessor.

23. The system of claim 15, wherein the first captured reference image within the first display window comprises an image of the entire sample.

24. The system of claim 23, wherein the first captured reference image of the entire sample is composed by stitching together at least two captured images comprising portions of the tissue sample.

25. The system of claim 15, wherein the selected section of the first captured reference image can be moved dynamically and is coupled to the second live image.

26. The system of claim 15, further comprising:
means for displaying a navigational toolbar on a video display; and
means for navigating the static image by translating the work surface comprising the sample relative to the image capture mechanism.

27. The system of claim 26, wherein the toolbar is controlled by a microprocessor.

28. The system of claim 26, wherein the toolbar is a virtual joystick.

29. The system of claim 26, further comprising means for predefined precision movements of the navigational toolbar.

30. The system of claim 29, wherein a precision movement of the navigational toolbar is a specified distance translated in a specified direction caused by at least one instruction to the navigational toolbar.

31. A method of selecting a section of a sample for microscopy using a road map image guide, the method comprising:
providing a microscope work surface comprising a sample;
capturing an image of at least a portion of the sample;
displaying a static first captured reference image within a first display window;
selecting a section of the first captured reference image; and
displaying a second live captured image within a second display window wherein the second live captured image corresponds to the selected section of the first captured reference image.

32. The method of claim 31, wherein the first captured reference image within the first display window comprises an image of the entire sample.

33. The method of claim 32, wherein composing the first captured reference image of the entire sample comprises stitching together at least two captured images comprising portions of the sample.

34. The method of claim 31, further comprising:
capturing the first captured reference image using a low resolution image capture mechanism; and
capturing the second live captured image using a high resolution image capture mechanism.

35. The method of claim 31, wherein selecting a section of the first captured reference image is coupled to capturing a live image of at least a portion of the sample.

36. The method of claim 35, comprising using a road map camera for capturing an image of at least a portion of the sample.

37. The method of claim 31, further comprising displaying a magnified image of the selected section of the sample.

38. The method of claim 37, wherein the magnified image of the selected section of the sample corresponds to at least a 2×magnification.

39. The method of claim 38, wherein the magnified image of the selected section of the sample corresponds to a magnification of 4×, 10×, 20×, 40× or 800×.

40. The method of claim 31, wherein selecting a section of the static first captured reference image is coupled with translating the microscope work surface relative to a location for capturing an image of the sample.

41. The method of claim 31, further comprising: displaying a navigational toolbar for navigating the static image by translating the sample relative to a location for capturing an image of the sample.

42. The method of claim 41, wherein the toolbar is controlled by a microprocessor.

43. The method of claim 41, comprising using a virtual joystick as the navigational toolbar.

44. The method of claim 41, further comprising:
using predefined precision movements of the navigational toolbar.
